(19) United States
(12) Patent Application Publication
(10) Pub. No.: US 2026/0217075 A1
(43) Pub. Date: Jul. 30, 2026

(54) COMPRESSED AIR GENERATION APPARATUS, AIR SPRING ARRANGEMENT, AND CAB MOUNTING SYSTEM

(71) Applicant: ZF Friedrichshafen AG, Friedrichshafen (DE)

(72) Inventors: Thomas NOWOTKA, Bundorf (DE); Manuel BEHNER, Lenggries (DE)

(73) Assignee: ZF Friedrichshafen AG, Friedrichshafen (DE)

(21) Appl. No.: 19/455,375

(22) Filed: Jan. 21, 2026

(30) Foreign Application Priority Data
Jan. 24, 2025 (DE) 102025102531.2

(51) Int. Cl. B60G 11/27; B60G 11/30; B60G 17/044

(52) U.S. Cl. CPC B60G 11/27; B60G 11/30; B60G 17/044; B60G 2202/152; B60G 2202/154; B60G 2204/162; B60G 2204/422; B60G 2500/205

(57) ABSTRACT

A compressed air generation apparatus for an air spring arrangement having an air spring and a passive compressed air generator. The compressed air generator converts relative displacements of its two portions in at least one direction into generation of compressed air. The first portion is coupled to a first connection point for connection to a first spring portion of the air spring of the air spring arrangement. The second portion is coupled via a linkage to a second connection point to a second spring portion of the air spring of the air spring arrangement. Translational relative movements between the connection points cause the relative displacement of the two portions with respect to one another. The linkage converts an adjusting movement introduced into the second connection point with an adjusting force into a higher actuation force and a lower actuation movement at the second portion of the compressed air generator.

### BACKGROUND OF THE INVENTION

### 1. Field of the Invention

The invention is directed to a compressed air generation apparatus which is provided for use in an air spring arrangement having an air spring and which comprises a passive compressed air generator. The compressed air generator has a first portion and a second portion which are translationally displaceable relative to one another. The compressed air generator converts relative displacements of its two portions in at least one direction into a generation of compressed air. The first portion of the compressed air generator is coupled to a first connection point which is provided in the compressed air generation apparatus for connection to a first spring portion of the air spring of the air spring arrangement, whereas the second portion of the compressed air generator is coupled via a linkage to a second connection point which is provided in the compressed air generation apparatus for connection to a second spring portion of the air spring of the air spring arrangement, and translational relative movements between the connection points causes the two portions to be displaced relative to one another. The invention is further directed to an air spring arrangement with an above-mentioned compressed air generation apparatus and a cab mounting system.

In cab mounting systems for utility vehicles, leveling devices are known via which a driver's cab can be maintained at a constant distance above the ground as part of a level control during travel of the respective utility vehicle. In addition, it is usually also possible to raise and lower the driver's cab relative to the vehicle frame especially when the utility vehicle is stationary. Usually, such cab mounting systems are provided with air springs in which a respective air mass in a respective air chamber of the individual air springs can be changed. To change the respective air mass, the respective air spring is often integrated in a compressed air system or can be supplied via a compressor. But beyond this, air spring arrangements are also known in which an air spring is combined with a compressed air generation apparatus. Such a compressed air generation apparatus then sometimes comprises a passive compressed air generator which generates compressed air in the manner of an air pump during oscillating vertical vibrations of the cab relative to the vehicle frame. This compressed air is then available for changing the air mass of the associated air spring.

### 2. Description of the Related Art

DE 10 2022 208 211 A1 discloses an air spring arrangement which comprises an air spring. The air spring is provided for use in a cab mounting system of a motor vehicle and has a rolling lobe which is connected in an airtight manner at one end to a mounting plate to delimit an air chamber of the air spring and is connected in an airtight manner at the other end to a roll-off piston. The mounting plate serves for connecting to a vehicle cab, while the roll-off piston is provided for connecting to a vehicle frame. Further, a compressed air generation apparatus comprising a passive compressed air generator is integrated in the air spring. This compressed air generator has a first portion in the form of a cylinder and a second portion in the form of a piston which is translationally displaceably guided in the cylinder. The cylinder and the piston define working spaces on both sides of the piston. Within the compressed air generation apparatus, the cylinder is coupled to a connection point at which a connection to the roll-off piston of the air spring is produced in the compressed air generation apparatus. On the other hand, the piston is coupled to another connection point via an intermediate linkage, and the compressed air generation apparatus is connected to the mounting plate of the air spring at this other connection point. Due to these couplings, relative movements between the mounting plate and the roll-off piston of the air spring are converted into stroke movements of the piston in the cylinder, as a result of which compressed air is correspondingly generated via the compressed air generation apparatus.

Proceeding from the prior art described above, the object of the present invention is to provide a compressed air generation apparatus in which a suitable compressed air generation is provided when used in an air spring arrangement.

### SUMMARY OF THE INVENTION

According to the invention, a compressed air generation apparatus provided for use in an air spring arrangement having an air spring comprises a passive compressed air generator. The compressed air generator has a first portion and a second portion which are translationally displaceable relative to one another. The compressed air generator converts relative displacements of its two portions in at least one direction into a generation of compressed air. The first portion of the compressed air generator is coupled to a first connection point which is provided for connection in the compressed air generation apparatus to a first spring portion of the air spring of the air spring arrangement, whereas the second portion of the compressed air generator is coupled via a linkage to a second connection point which is provided for connection in the compressed air generation apparatus to a second spring portion of the air spring of the air spring arrangement. Translational relative movements between the connection points causes the two portions to be displaced relative to one another.

To this end, the compressed air generation apparatus according to the invention is provided for use in an air spring arrangement which is outfitted with an air spring. In this case, the compressed air generation apparatus could be designed as a retrofit kit with which an already installed air spring arrangement is retrofitted.

The compressed air generation apparatus has a compressed air generator in which two portions are guided so as to be displaceable relative to one another. In particular, during operation of the compressed air generation apparatus, the two portions of the compressed air generator execute oscillating reciprocating movements which are converted in the compressed air generator into a generation of compressed air in at least one direction, i.e., either when the two portions move toward one another or away from one another. The compressed air generator is constructed to be passive, i.e., the compressed air generator cannot itself bring about the relative displacements of its two portions; rather, the movements causing the relative displacements must be initiated in the compressed air generator from the outside. Preferably, the compressed air generator is configured to be double-acting in that pressure is generated in both directions in which the portions are displaced relative to one another.

On the one hand, the first portion of the compressed air generator is coupled to a first connection point in the compressed air generation apparatus, and the compressed air generation apparatus according to the invention is to be connected to a first spring portion of the air spring in the air spring arrangement by this first connection point. On the other hand, there is a coupling between the second portion of the compressed air generator and a further, second connection point of the compressed air generation apparatus according to the invention. This second connection point serves to connect to a second spring portion of the air spring when the compressed air generation apparatus according to the invention is used in the air spring arrangement.

Within the meaning of the invention, the respective coupling is to be understood as meaning that a position or movement of the respective connection point influences a position or movement of the respective portion of the compressed air generator, and vice versa. With regard to the first connection point and the first portion, this coupling can be, within the meaning of the invention, a rigid connection as a result of which a change in position or movement of the first connection point brings about an identical change in position or identical movement of the first portion, and vice versa. In contrast, the coupling between the second connection point and the second portion of the compressed air generator is produced via an intermediate linkage.

The invention comprises the technical teaching that the linkage converts an adjusting movement introduced into the second connection point with an adjusting force into a higher actuation force and a lower actuation movement at the second portion of the compressed air generator. In other words, the linkage achieves a transmission ratio between the second portion and the second connection point in that the linkage converts an adjusting force introduced at the second connection point into an actuation force at the second portion and converts an adjusting movement generated at the second connection point by the adjusting force into an actuation movement at the second portion. The transmission ratio realized via the linkage is selected such that the actuation force generated at the second portion is higher than the adjusting force introduced at the second connection point and such that the actuation movement generated at the second portion is smaller than the adjusting movement brought about at the second connection point.

This configuration of a compressed air generation apparatus has the advantage that, due to the inventive construction of the compressed air generation apparatus, a lower adjusting force is required at the connection points for actuation of the passive compressed air generator. This is because the adjusting force introduced at the second connection point is increased with respect to the second portion of the compressed air generator due to the transmission ratio realized via the linkage, so that relative movements between the two connection points are ultimately converted into smaller stroke movements of the two portions at higher actuation forces. When the compressed air generation apparatus according to the invention is used in an air spring arrangement, the reaction of the compressed air generation apparatus on the air spring can be minimized and a sensitive response behavior of the air spring can accordingly be maintained in spite of the use of the compressed air generation apparatus. At the same time, a suitable compressed air generation is realized via the compressed air generation apparatus according to the invention.

The compressed air generation apparatus according to the invention is designed particularly to be arranged external to the air spring in the air spring arrangement. In particular, the passive compressed air generator is provided for a collinear arrangement in the air spring arrangement with respect to the air spring.

By “linkage” is meant within the framework of the invention, in particular, a construction in which at least one rod-shaped or bar-shaped transmission element produces the coupling between the second portion and the second connection point. The transmission ratio required in accordance with the invention between the second connection point and the second portion of the compressed air generator is achieved by means of the coupling via the at least one transmission element. Connections of the at least one transmission element are carried out in particular via joints. It is particularly preferred that the linkage comprises a plurality of rod-shaped or bar-shaped transmission elements.

According to one embodiment form of the invention, the linkage has a first swing arm, a second swing arm and a coupling rod. The coupling rod is connected at a first coupling point located at one end of the coupling rod via a first swivel joint to the first swing arm which is also connected at a second swivel joint to the second connection point of the compressed air generation apparatus. At a second coupling point located at another end of the coupling rod, the coupling rod is connected via a third swivel joint to the second swing arm which is also connected via a fourth swivel joint to the first connection point of the compressed air generation apparatus. Further, at a third coupling point which lies between the first coupling point and the second coupling point so as to be off-center in direction of the second coupling point, the coupling rod is connected to the second portion of the compressed air generator via a fifth swivel joint. This allows the required conversion to be realized via the linkage with a low number of components. In addition, this construction has proven to be advantageous for realizing nearly symmetrical tensile forces and compressive forces for actuation of the compressed air generator.

According to one possible configuration of the invention, the two portions of the compressed air generator carry out stroke movements relative to one another during the relative displacement. These stroke movements are limited to a stroke range between a top dead center and a bottom dead center in that, when one of the dead centers is reached, leaving the stroke range is prevented by decoupling one of the portions of the compressed air generator from the associated connection point. As a result, the compressed air generation apparatus according to the invention can be used universally in different air spring arrangements without needing to additionally adapt the compressed air generator to a respective travel of the respective air spring. This is because decoupling the respective portion of the compressed air generator from the associated connection point prevents exiting the stroke range between the dead centers, so that the compressed air generator can also be combined with an air spring that could lead to an impermissibly large stroke because of the stroke that could be performed on the part of the compressed air generator.

When combining the two variants described above, the decoupling can be achieved by designing the coupling rod to be flexible in that the third coupling point can be laterally displaced relative to a connecting axis that extends between the first coupling point and the second coupling point. By designing the coupling rod to be flexible, the decoupling of the second portion of the compressed air generator from the second connection point can be achieved in a simple and, at the same time, a reliable manner to prevent it from leaving the stroke range.

Preferably, the coupling rod is divided into two segments, one of which extends between the first coupling point and the third coupling point and can be tilted at the third coupling point relative to the second segment which extends between the third coupling point and the second coupling point. In this case, the tilting of the segments relative to one another is limited in both tilting directions via stops. The flexible design of the coupling rod can easily be realized in this way. Alternatively, the bending stiffness of an integrally configured coupling rod could also be adapted to the desired characteristic, for example, by selecting a material having a corresponding strength and/or by dimensioning the coupling rod correspondingly.

When the coupling rod is divided into two segments, the segments are preferably outfitted in the region of the third coupling point with paired stop surfaces. Contact then takes place at the stop surfaces associated with one another in each of the two tilting directions from a defined tilting angle between the segments. In this way, the respective deflection of the coupling rod can be reliably limited in rebound direction as well as in compression direction. It is particularly preferable that a stop buffer is provided at each of the stop surfaces associated with one another.

In a further embodiment form of the invention, the compressed air generator is configured as a piston pump in which a piston is displaceably guided in a cylinder and, together with the cylinder, in each instance delimits a working chamber on at least one side in displacement direction. One component of the piston and cylinder forms the first portion of the compressed air generator and the other component forms the second portion of the compressed air generator. In this way, compressed air generation can be realized in a simple manner. It is particularly preferred that the piston along with the cylinder delimits working chambers on both sides of the piston in displacement direction. As a result, each piston pump is implemented as a double-acting pump so that compressed air is generated in both displacement directions of the piston in the cylinder.

When the compressed air generator is constructed as a piston pump, decoupling can be achieved in that the cylinder is linearly displaceably guided in a housing which is connected to the first connection point. When one of the dead centers is reached, instead of exiting the stroke range, there occurs a relative displacement of the cylinder with respect to the housing. In particular, the housing is rigidly connected to the first connection point. The linearly displaceable guidance of the cylinder in the housing is preferably carried out along a displacement axis along which displacements of the piston in the cylinder also occur.

Particularly preferably, the cylinder is preloaded in a basic position in the housing via spring elements acting on the cylinder in the opposite direction of displacement. This prevents the movement initiated via the linkage from always being converted into a relative displacement of the cylinder with respect to the housing instead of resulting in displacements of the piston in the cylinder. The two spring elements must therefore provide such a preloading which is not exceeded during strokes of the piston taking place in the cylinder within the stroke range, but only when leaving the stroke range.

It is particularly preferable that an inlet valve and an outlet valve are associated in each instance with a working chamber, as a result of which air can be supplied to each working chamber via a respective inlet valve, and compressed air can be discharged from each working chamber via a respective outlet valve. This allows air to be sucked into the respective working chamber and compressed air to be compressed and discharged from the respective working chamber in a particularly reliable manner. In particular, the valves are configured in each instance as check valves.

The invention is further directed to an air spring arrangement which is provided in particular for use in a cab mounting system. This air spring arrangement comprises a compressed air generation apparatus according to one or more of the variants described above and an air spring which has a first spring portion and a second spring portion. An air chamber via which the two spring portions are pneumatically coupled to one another is formed between the spring portions. Further, the first connection point of the compressed air generation apparatus is coupled to the first spring portion and the second connection point of the compressed air generation apparatus is coupled to the second spring portion. Accordingly, by using the compressed air generation apparatus according to the invention in the air spring arrangement, compressed air can be generated by the passive compressed air generator when the two spring portions move relative to one another, as a result of which low actuation forces are required for this due to the transmission ratio realized via the linkage. In this way, reactions on the air spring can be kept low and a sensitive response of the air spring can accordingly be maintained. In particular, the compressed air generation apparatus is arranged outside the air spring with the passive compressed air generator particularly preferably being placed collinear with the air spring.

Particularly preferably, the stroke range in the compressed air generation apparatus is limited in that the stroke range is exited by decoupling one of the portions of the compressed air generator from the associated connection point and therefore from the respective spring portion of the air spring. In this way, the air spring combined with the compressed air generator can also be implemented with a travel that would otherwise actually lead to the passive compressed air generator exiting the stroke range between the dead centers.

The air spring of the air spring arrangement preferably comprises a mounting plate and a roll-off piston, the mounting plate forming the one spring portion of the air spring and the roll-off piston forming the other spring portion of the air spring. Also provided in particular is a rolling lobe which is connected to the mounting plate in an airtight manner at one end and to the roll-off piston in an airtight manner at the other end so as to delimit the air chamber of the air spring.

The compressed air generated by the compressed air generation apparatus can be used in the air spring arrangement according to the invention particularly to change the air mass in the air spring. For this purpose, the air spring arrangement is preferably outfitted with a valve which can cause compressed air to be fed into the air chamber of the air spring in order to increase the air mass.

Within the framework of the invention, the coupling of the spring portions to the respective connection point of the compressed air generation apparatus is, in particular, a rigid connection in each instance. The respective connection can be direct, but is preferably realized indirectly via further, intermediate component parts.

In one embodiment form of the air spring arrangement, the compressed air generator of the compressed air generation apparatus is connected via a connection line to a pressure reservoir which can be filled with compressed air generated by the compressed air generator via the connection line and which communicates with the air spring via a supply line. Further, the air chamber of the air spring can be supplied with compressed air from the pressure reservoir via the supply line. In this way, the air spring arrangement according to the invention stores compressed air that has been generated by the passive compressed air generator. This stored compressed air can then be used to change the air mass in the air chamber of the air spring.

Alternatively, but preferably additionally, the compressed air generator is connected via a connection line to a pressure reservoir from which the compressed air generator can be supplied with air via the connection line and which communicates with the air spring via a discharge line, and air from the air chamber of the air spring can be discharged into the pressure reservoir via the discharge line. In this case, when the air mass in the air chamber is reduced, air is not discharged into the environment but is discharged into the associated pressure reservoir from which the passive compressed air generator can draw air for compressing the air.

Within the framework of the invention, the air spring can be combined with a telescopic vibration damper to form a spring carrier. In principle, the telescopic vibration damper can be a monotube damper or a two-tube damper.

The invention is further directed to a cab mounting system in which at least one air spring arrangement is provided according to one or more of the variants described above. This cab mounting system is used in particular for mounting a driver's cab in a utility vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Advantageous embodiment forms of the invention, which are explained below, are shown in the drawings. The drawings show:

FIG. 1 is a schematic representation of a cab mounting system;

FIG. 2 is a view of an air spring arrangement of the cab mounting system from FIG. 1 corresponding to a first embodiment form of the invention;

FIGS. 3A to 3C are views of different states of a linkage of a compressed air generation apparatus of the air spring arrangement from FIG. 2;

FIG. 4 is a view of an air spring arrangement, according to a second possible embodiment of the invention, shown in a first state; and

FIG. 5 is a detail view of the air spring arrangement from FIG. 4 shown in a second state.

### DESCRIPTION OF THE DISCLOSED EMBODIMENTS

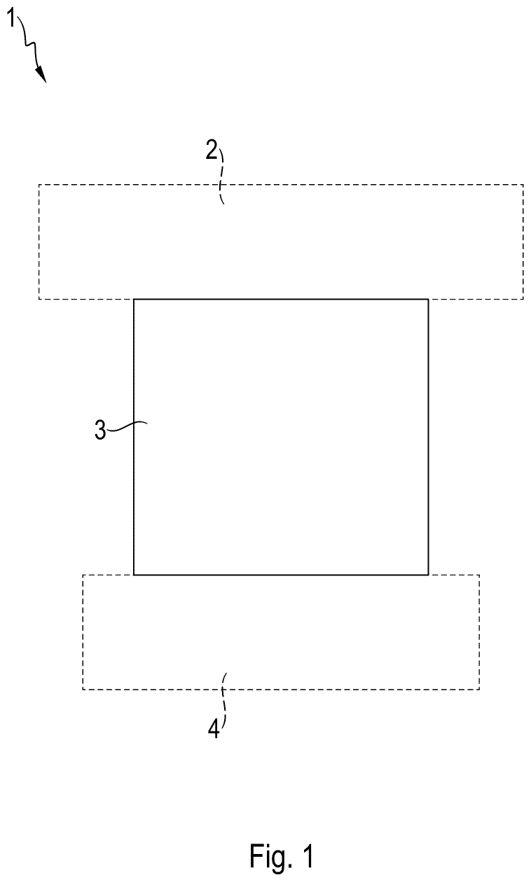

FIG. 1 shows a schematic representation of a cab mounting system 1 in which a vehicle cab 2—shown here highly schematically—is mounted on a vehicle frame 4 via an air spring arrangement 3. The latter is also shown only highly schematically in FIG. 1. The cab mounting system 1 is preferably designed for use in a utility vehicle. In addition, the vehicle cab 2 in the cab mounting system 1 is mounted on the vehicle frame 4 in particular via a plurality of such air spring arrangements 3.

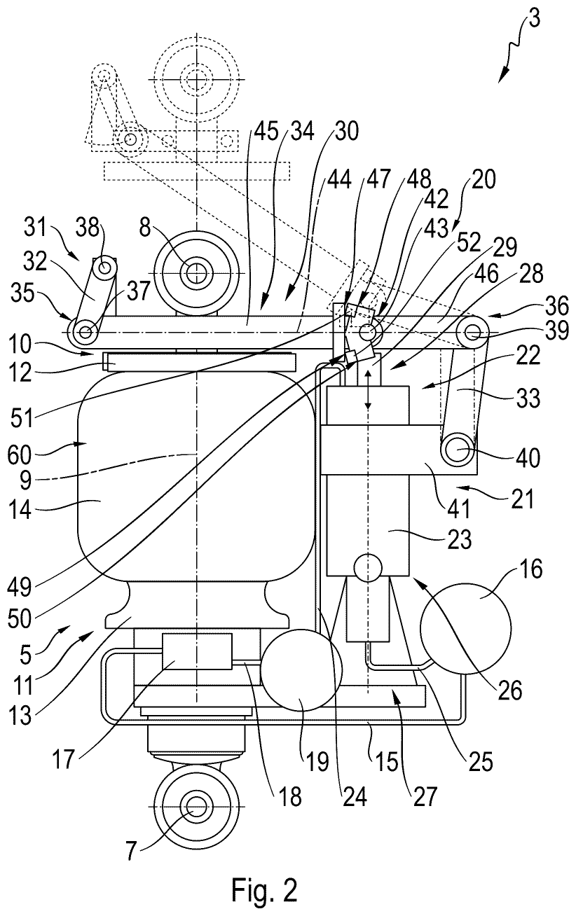

FIG. 2 shows an isolated view of the air spring arrangement 3 which is configured in accordance with a first embodiment form of the invention. The air spring arrangement 3 comprises a spring carrier 5 which comprises an air spring 6 and a telescopic vibration damper, not shown in FIG. 2. The air spring 6 and the telescopic vibration damper are arranged in the spring carrier 5 parallel to one another between two fastening points 7 and 8 which are configured as fastening eyes in this case. Fastening point 7 serves for fastening the spring carrier 5 to the vehicle frame 4, while fastening point 8 is provided for fastening the spring carrier 5 to the vehicle cab 2.

As is indicated in FIG. 2 on the one hand by the representation of the air spring arrangement 3 in solid lines and on the other hand by the representation of part of the air spring arrangement 3 shown in dashed lines, the two fastening points 7 and 8 can be displaced relative to one another along an axis 9 of the spring carrier 5. The air spring 6 comprises two spring portions 10 and 11 in the form of a mounting plate 12 and a roll-off piston 13. The mounting plate 12 forming spring portion 10 is rigidly connected to fastening point 8, whereas the roll-off piston 13 forming spring portion 11 is rigidly connected to fastening point 7. Further, the air spring 6 has a rolling lobe 14 which is connected in an airtight manner at one end to the mounting plate 12 and in an airtight manner at the other end to the roll-off piston 13 and defines an air chamber—not shown in FIG. 2—of the air spring 6. The mounting plate 12 and the roll-off piston 13 are pneumatically coupled to one another via the air chamber.

An air mass in the air chamber of the air spring 6 can be selectively changed in the air spring arrangement 3 in order to displace the two fastening points 7 and 8 relative to one another accompanied by the rolling of the rolling lobe 14 at the roll-off piston 13 and, in this way, to also change the level of the vehicle cab 2 above the vehicle frame 4. Accordingly, on the one hand, the air spring 6 is connected via a supply line 15 to a pressure reservoir 16 in which compressed air is stored. Via a valve 17, indicated only schematically in FIG. 2, the air chamber of the air spring 6 can be selectively connected to the supply line 15, and therefore also to the pressure reservoir 16, in order to feed compressed air into the air chamber and therefore increase the air mass in the air chamber. On the other hand, the valve 17 can also connect the air chamber to a discharge line 18 via which a connection is further established to a pressure reservoir 19. By establishing the connection from the air chamber to the discharge line 18, the air mass in the air chamber can be reduced by discharging air into the pressure reservoir 19.

Also part of the air spring arrangement 3 is a compressed air generation apparatus 20 which is arranged in the air spring arrangement 3 outside of the spring carrier 5 and, therefore, also outside of the air spring 6. This compressed air generation apparatus 20 is formed in accordance with a first possible embodiment of the invention and comprises a passive compressed air generator 21 which is configured as a piston pump 22. The piston pump 22 has a cylinder 23 in which a piston, not shown in FIG. 2, is displaceably guided. This is indicated in FIG. 2 by a double arrow.

Displacements of the piston in the cylinder 23 result in the generation of compressed air by the piston pump 22 with the piston pump 22 operating as a double-acting pump in that compressed air is generated in both displacement directions of the piston. On the one hand, the piston pump 22 is connected via a connection line 24 to the pressure reservoir 19 from which the piston pump 22 can draw in air for subsequent compression. On the other hand, a connection is established between the piston pump 22 and the pressure reservoir 16 via a connection line 25 via which the pressure reservoir 16 can be filled with the compressed air generated by the piston pump 22.

In the present case, the cylinder 23 forms a first portion 26 of the compressed air generator 21. This first portion 26, and therefore also the cylinder 23, is rigidly connected in the compressed air generation apparatus 20 to a first connection point 27 at which the compressed air generation apparatus 20 communicates with the spring portion 11 in the form of roll-off piston 13. This connection is also implemented as a rigid connection between roll-off piston 13 and connection point 27.

A second portion 28 of the compressed air generator 21 is formed by the piston—not shown—of the piston pump 22, which piston is arranged at one end of a piston rod 29 which is guided out of the cylinder 23 in the piston pump 22. The piston is connected to a second connection point 31 of the compressed air generation apparatus 20 via the piston rod 29 and a linkage 30. The compressed air generation apparatus 20 is connected at this second connection point 31 to the spring portion 10 in the form of mounting plate 12, this connection to the spring portion 10 being configured as a rigid connection.

The linkage 30 comprises two swing arms 32 and 33 and a coupling rod 34, a coupling point 35 and 36 being formed at both ends thereof, respectively. The coupling rod 34 is connected at its coupling point 35 via a swivel joint 37 to one end of the swing arm 32 which is also connected at an end opposite thereto via a swivel joint 38 to the second connection point 31 and, accordingly, also to the mounting plate 12. Further, the coupling rod 34 is connected at coupling point 36 to one end of the swing arm 33 via a swivel joint 39, and the swing arm 33 is further articulated at another end to a lever 41 by means of a swivel joint 40. This lever 41 is rigidly connected to the cylinder 23 and accordingly also to the first connection point 27 of the compressed air generation apparatus 20.

In addition to the coupling points at 35 and 36, the coupling rod 34 has a further coupling point 42 which is located off-center between coupling points 35 and 36 in direction of coupling point 36. At this coupling point 42, the coupling rod 34 is connected to the piston rod 29 via a swivel joint 43. In this way, a transmission ratio between the spring carrier 5 and the compressed air generator 21 of the compressed air generation device 20 is so implemented via the linkage 30 that an adjusting movement initiated with an adjusting force by a relative displacement of the fastening points 7 and 8 is converted into a smaller relative displacement of the piston with respect to the cylinder 23 of the piston pump 22 with a higher actuation force. This allows the compressed air generator 21 to generate compressed air when the fastening points 7 and 8 and, therefore, the vehicle cab 2 move relative to the vehicle frame 4, as a result of which, due to the transmission ratio realized via the linkage 30, a low reaction on the spring carrier 5 and, therefore, a sensitive response of the spring carrier 5 is achieved. When the compressed air generator 21 is actuated, the linkage 30 brings about virtually symmetrical tensile forces and compressive forces on the spring carrier 5.

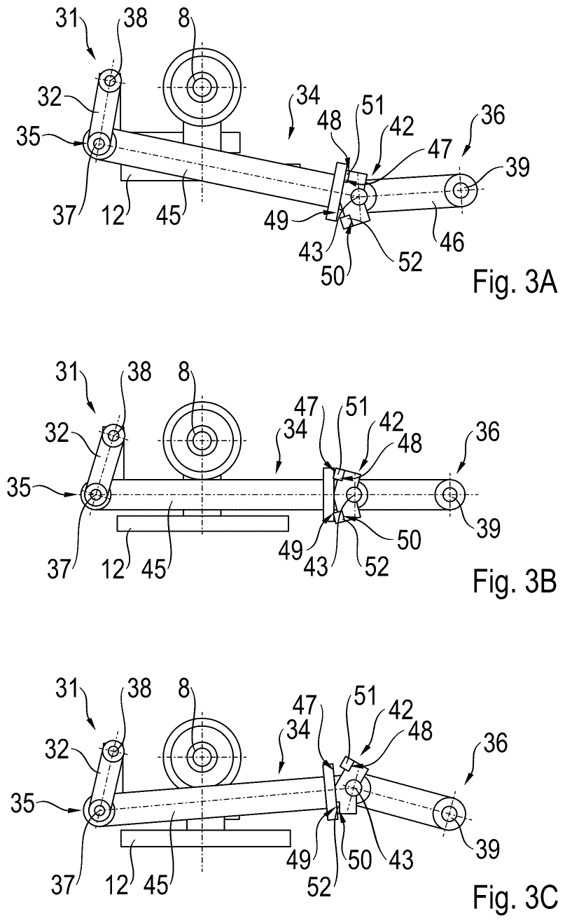

The displacements of the piston in cylinder 23 take place between dead centers in piston pump 22. In order to be able to combine the piston pump 22 and, therefore, the compressed air generation apparatus 20 universally with different spring carriers and at the same time prevent the piston pump 22 from being subjected to movements beyond these dead centers, the coupling rod 34 is configured to be flexible in the present case. Due to this flexible configuration, the coupling point 42 in coupling rod 34 can displace laterally relative to a connecting axis 44 which extends between coupling points 35 and 36 and which is indicated in FIG. 2. Aside from the representation shown in dashed lines in FIG. 2, this can also be seen from parts of FIGS. 3A to 3C which respectively show the area of the linkage 30 for different states.

The linkage 30 is shown in FIG. 3A when the spring carrier 5 is in tension, in FIG. 3B in a middle position, and in FIG. 3C when the spring carrier 5 is in compression. Due to the lateral displaceability of the coupling point 42, the fastening points 7 and 8 can still be moved farther relative to one another even when one of the dead centers has already been reached in the piston pump 22. This allows the compressed air generation apparatus 20 to be combined with a spring carrier 5 whose stroke does not actually match the compressed air generator 21 of the compressed air generation apparatus 20.

For purposes of the flexible configuration, the coupling rod 34 is divided at coupling point 42 into two segments 45 and 46 which can be tilted relative to one another at coupling point 42. The segments 45 and 46 are outfitted at coupling point 42 with stop surfaces 47, 48 and 49, 50, respectively, which face one another and which are associated with one another pairwise. The paired stop surfaces 47, 48 and 49, 50, respectively, form stops which limit the tilting of the two segments 45 and 46 each in a tilting direction. Further, segment 46 is provided with stop buffers 51 and 52 at its stop surfaces 48 and 50 in each instance.

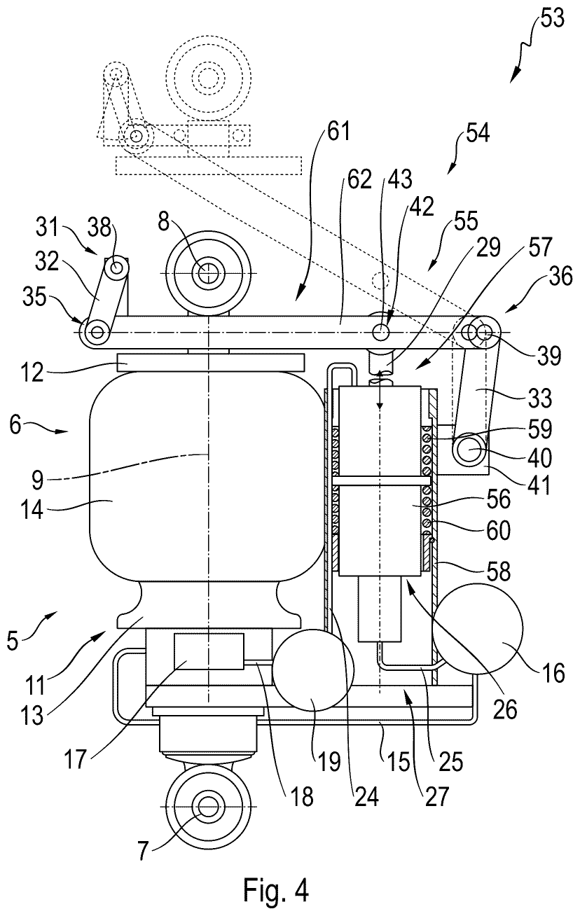

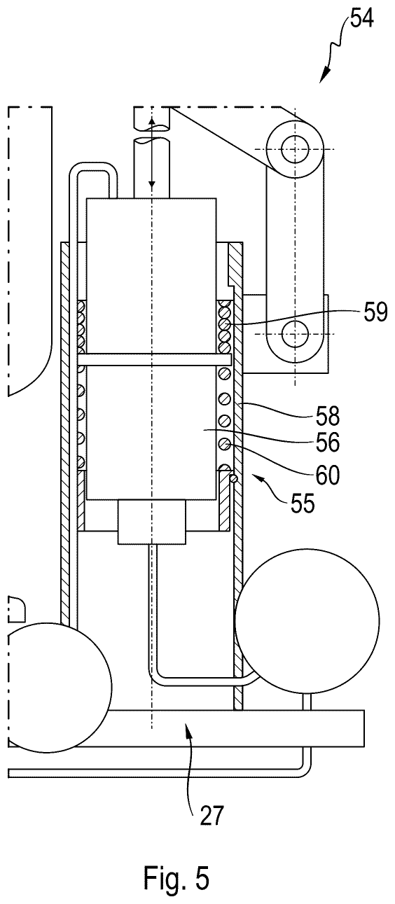

Further, FIGS. 4 and 5 show views of an air spring arrangement 53 corresponding to a second embodiment of the invention. This air spring arrangement 53 can be used as an alternative to the air spring arrangement 3 in the cab mounting system 1 in FIG. 1. The air spring arrangement 53 largely corresponds to the variant shown in FIG. 2, with the difference that the air spring arrangement 53 is outfitted with a compressed air generation apparatus 54 realized in accordance with a further embodiment form of the invention. This compressed air generation apparatus 54 comprises a passive compressed air generator 55 in which a cylinder 56 of a piston pump 57 is not rigidly connected to the connection point 27 of the compressed air generation apparatus 54, but is guided in a linearly displaceable manner in a housing 58 so that the compressed air generation apparatus 54 may be combined with different spring carriers in a universal manner. This housing 58 is then rigidly connected to connection point 27 and, besides this, guides the lever 41 to which the swing arm 33 is articulated.

The cylinder 56 is preloaded in the housing 58 in a basic position which is achieved via spring elements 59 and 60 that act oppositely with respect to one another on the cylinder 56. In this way, a spring balance is realized via the spring elements 59 and 60 in order, on the one hand, to bring about a relative displacement of a piston—also not shown in FIGS. 4 and 5—of the piston pump 57 in the cylinder 56 when a movement is initiated via a linkage 61 of the compressed air generation apparatus 54 and, therefore, to realize compressed air generation in the piston pump 57. On the other hand, however, once one of the dead centers of the piston pump 57 has been reached, a further movement of the fastening points 7 and 8 relative to one another can nevertheless take place in that the cylinder 56 is then displaced against one of the spring elements 59 and 60 in the housing 58. Due to the possibility for compensation that is now realized in the region of the piston pump 57, a coupling rod 62 of the linkage 61 is not divided into segments, in contrast to the variant shown in FIG. 2, but is configured integrally. The embodiment according to FIGS. 4 and 5 otherwise corresponds to the variant shown in FIG. 2 and, accordingly, reference is made to the description provided therein.

By means of the configurations according to the invention, a compressed air generation apparatus can be provided which, when used in an air spring arrangement, can generate compressed air in a suitable manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A compressed air generation apparatus which is provided for use in an air spring arrangement having an air spring and which comprises a passive compressed air generator, wherein the compressed air generator has a first portion and a second portion which are translationally displaceable relative to one another, wherein the compressed air generator converts relative displacements of its two portions in at least one direction into generation of compressed air, wherein the first portion of the compressed air generator is coupled to a first connection point which is provided in the compressed air generation apparatus for connection to a first spring portion of the air spring of the air spring arrangement, whereas the second portion of the compressed air generator is coupled via a linkage to a second connection point which is provided in the compressed air generation apparatus for connection to a second spring portion of the air spring of the air spring arrangement, and wherein translational relative movements between the connection points cause the relative displacement of the two portions, wherein the linkage converts an adjusting movement introduced into the second connection point with an adjusting force into a higher actuation force and a lower actuation movement at the second portion of the compressed air generator.

2. The compressed air generation apparatus according to claim 1, wherein the linkage has a first swing arm, a second swing arm and a coupling rod, wherein the coupling rod is connected at a first coupling point located at one end of the coupling rod via a first swivel joint to the first swing arm, which communicates in addition at a second swivel joint with the second connection point of the compressed air generation apparatus, and is connected at a second coupling point located at another end of the coupling rod via a third swivel joint to the second swing arm which is further connected at a fourth swivel joint to the first connection point of the compressed air generation apparatus, wherein the coupling rod is connected to the second portion of the compressed air generator via a fifth swivel joint at a third coupling point which is arranged off-center between the first coupling point and the second coupling point in direction of the second coupling point.

3. The compressed air generation apparatus according to claim 1, wherein the two portions of the compressed air generator carry out stroke movements relative to one another during relative displacement, and these stroke movements are limited to a stroke range between a top dead center and a bottom dead center in that, when one of the dead centers is reached, exiting from the stroke range is prevented by decoupling one of the portions of the compressed air generator from the associated connection point.

4. The compressed air generation apparatus according to claim 2, wherein the decoupling is achieved by means of a flexible configuration of the coupling rod in that the third coupling point is laterally displaceable relative to a connecting axis which extends between the first coupling point and the second coupling point.

5. The compressed air generation apparatus according to claim 4, wherein the coupling rod is divided into two segments, one of which extends between the first coupling point and the third coupling point and is tiltable at the third coupling point relative to the second segment which extends between the third coupling point and the second coupling point, wherein the tilting of the segments relative to one another is limited in both tilting directions by stops.

6. The compressed air generation apparatus according to claim 5, wherein the segments are outfitted in the area of the third coupling point with stop surfaces which are associated with one another pairwise, wherein a contact takes place at the stop surfaces, which are associated with one another, in each of the two tilting directions from a defined tilting angle between the segments.

7. The compressed air generation apparatus according to claim 1, wherein the compressed air generator is configured as a piston pump in which a piston is displaceably guided in a cylinder, and a working chamber is delimited in each instance by the cylinder in displacement direction on at least one side, wherein one component, either the piston or the cylinder, forms the first portion of the compressed air generator and the other component forms the second portion of the compressed air generator.

8. The compressed air generation apparatus according to claim 3, wherein the decoupling is achieved in that the cylinder is linearly displaceably guided in a housing which is connected to the first connection point, wherein, instead of leaving the stroke range, a relative displacement of the cylinder relative to the housing occurs when one of the dead centers is reached.

9. The compressed air generation apparatus according to claim 8, wherein the cylinder is preloaded in a basic position in the housing via spring elements acting on the cylinder oppositely in displacement direction.

10. An air spring arrangement for a cab mounting system, comprising a compressed air generation apparatus according to claim 1 and an air spring which has a first spring portion and a second spring portion, wherein an air chamber is formed between the spring portions via which the two spring portions are pneumatically coupled to one another, and wherein the first connection point of the compressed air generation apparatus is coupled to the first spring portion and the second connection point of the compressed air generation apparatus is coupled to the second spring portion.

11. The air spring arrangement according to claim 10, wherein the compressed air generator of the compressed air generation apparatus is connected via a connection line to a pressure reservoir which is fillable via the connection line with compressed air generated by the compressed air generator and communicates with the air spring via a supply line, wherein the air chamber of the air spring can be supplied with compressed air from the pressure reservoir via the supply line.

12. The air spring arrangement according to claim 10, wherein the compressed air generator is connected via a connection line to a pressure reservoir from which the compressed air generator can be supplied with air via the connection line and communicates with the air spring via a discharge line, wherein air can be discharged from the air chamber of the air spring into the pressure reservoir via the discharge line.

13. The air spring arrangement according to claim 10, wherein the air spring is combined with a telescopic vibration damper to form a spring carrier.

14. A cab mounting system comprising at least one air spring arrangement according to claim 10.
